(19) United States
(12) Patent Application Publication
(10) Pub. No.: US 2024/0388883 A1
(43) Pub. Date: Nov. 21, 2024

(54) PACED MULTL-BAND OPERATION SCANNING SCHEME FOR FAST THROUGHPUT ROAMING

(71) Applicant: Cisco Technology, Inc., San Jose, CA (US)

(72) Inventors: Jerome HENRY, Pittsboro, NC (US); Robert E. BARTON, Richmond (CA); Mir A. ALAMI, Torrence, CA (US)

(21) Appl. No.: 18/656,331

(22) Filed: May 6, 2024

Related U.S. Application Data
(60) Provisional application No. 63/503,092, filed on May 18, 2023.

(51) Int. Cl. H04W 8/02

(52) U.S. Cl. CPC H04W 8/02

(57) ABSTRACT

Disclosed herein are a method and system for aiding a station to roam to a new AP. The AP associates with the station and receives a table of the AP beacons the station detected prior to association. The AP sends a beacon report request with one or more condition requests to the station. The station responds by negotiating with the AP regarding the condition request. The AP then receives a beacon report from the station based on the negotiated condition request. Conditions to be negotiated include how often to report on the RF conditions of the station, the station's battery power, the station's traffic, and specific channels for sending the beacon report.

### CROSS-REFERENCE TO RELATED APPLICATIONS

This application claims the benefit of co-pending U.S. provisional patent application Ser. No. 63/503,092 filed May 18, 2023. The aforementioned related patent application is herein incorporated by reference in its entirety.

### TECHNICAL FIELD

Embodiments presented in this disclosure generally relate to a station connecting to a different access point. More specifically, embodiments disclosed herein relate to a station making an informed decision to connect to a different access point.

### BACKGROUND

A station in an extended service set (ESS) with many APs and other stations may move (i.e., roam) about within the ESS. When moving, the station may develop a poor connection with its current AP and need to move to a better AP. When there are many APs in the ESS, the station may already have lost signal strength with the current AP before it scans to find a better AP, thereby wasting air time with transmission retries. When there are fewer APs in the ESS, the station may start searching for a new AP long before finding another suitable AP, thereby wasting airtime and battery power. There is a need for the current AP to help the station make a more intelligent roaming decision.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an ESS infrastructure, according to embodiments.

FIG. 2A depicts a representative architecture of an access point (AP), according to embodiments.

FIG. 2B depicts a representative architecture of a station, according to embodiments.

FIG. 3 depicts a flow of operations at the AP, according to embodiments.

FIG. 4 depicts a flow of operations for making a measurement request with one or more conditions, according to embodiments.

FIG. 5 depicts a flow of operations for negotiation between the AP and a station, according to embodiments.

FIG. 6 depicts a flow of operations at a station, according to embodiments.

FIG. 7 depicts a measurement request frame, according to embodiments.

FIG. 8 depicts a measurement report frame, according to embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method of roaming. The method includes: associating with a station; sending to the station a beacon report request (BRR) with one or more conditions; performing a negotiation with the station with respect to the BRR; receiving a beacon report from the station based on the BRR and the negotiation; and informing the station of an AP to which to roam according to the beacon report. The one or more conditions include reporting whether the radio frequency (RF) conditions of the station have changed, the station reporting whether the station's batter exceeds a threshold, the station reporting whether its traffic is less than a threshold, or the station reporting when the ranging information to the AP has changed.

Another embodiment presented in this disclosure is an access point that includes a processor and a memory coupled to the processor and loaded with a program executable by the processor to: associate with a station; send to the station a beacon report request (BRR) with one or more conditions; performing a negotiation with the station with respect to the BRR; receive a beacon report from the station based on the BRR and the negotiation; and inform the station of an AP to which to roam according to the beacon report.

Yet another embodiment presented in this disclosure is a station that includes a processor and a memory coupled to the processor and loaded with a program executable by the processor to: associate with an access point (AP); receive a beacon report request (BRR) with one or more conditions from the AP; perform a negotiation with the access point with respect to the BRR; send a beacon report to the AP based on the BRR and the negotiation; and receive from the AP an AP to which to roam.

### Example Embodiments

The 802.11k standard is designed to provide information to a station so that it can discover and switch (i.e., roam) to the best available AP. An 802.11k-capable AP can send beacon report request to its 802.11k stations. Such a beacon report request is a measurement request frame (a type of action frame) sent less often than beacon management frames. Using measurement request frames, an 802.11k-capable network can make better roaming decisions and balance traffic over the available APs. In the embodiments described herein, the AP's measurement request frames may include condition requests in which stations provide (i) the RF conditions of the station, (ii) the state of the battery in the station, (iii) the traffic currently being handled by the station, and (iv) the ranging information to the access point. The AP may also specify the channels for the stations to send the report.

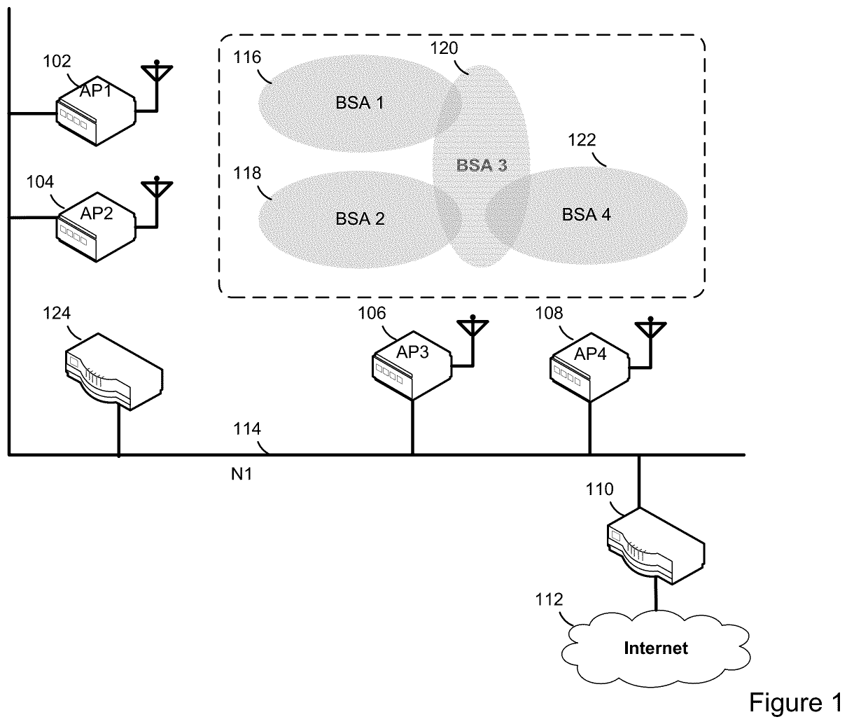

FIG. 1 depicts an ESS infrastructure, according to embodiments. The ESS includes AP 1 (102), 2 (104), 3 (106), and 4 (108), BSA 1 (116), 2 (118), 3 (120), and 4 (122), all coupled together with a wired network N1 114. The basic service area (BSA) is an area in which stations can communicate with other stations and access points in the BSA. The network N1 114 is coupled to a wireless LAN controller (WLC) 124 and a router 110, which, in turn, is coupled to the Internet 112.

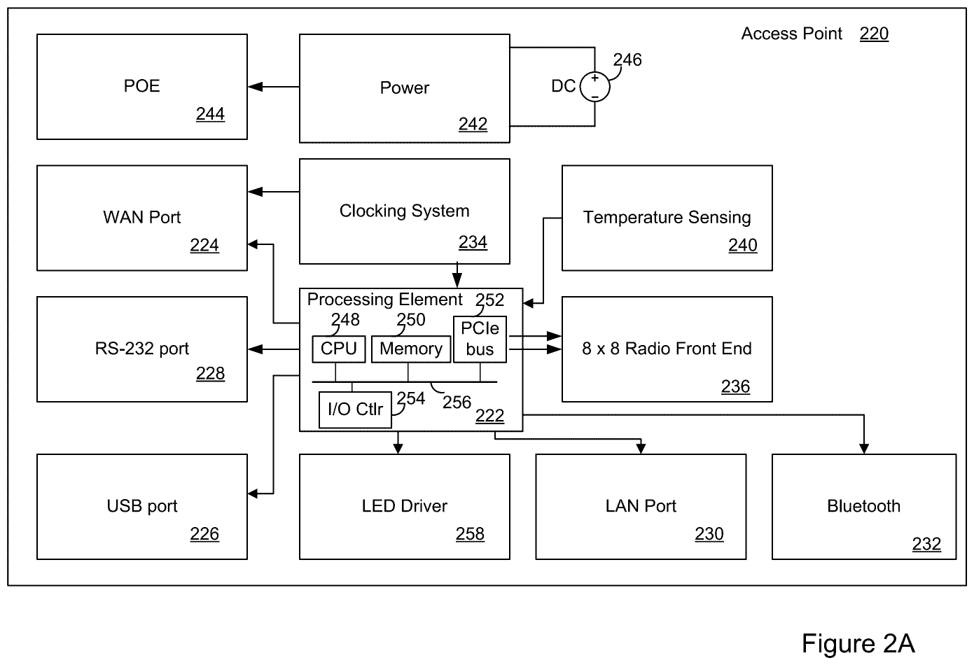

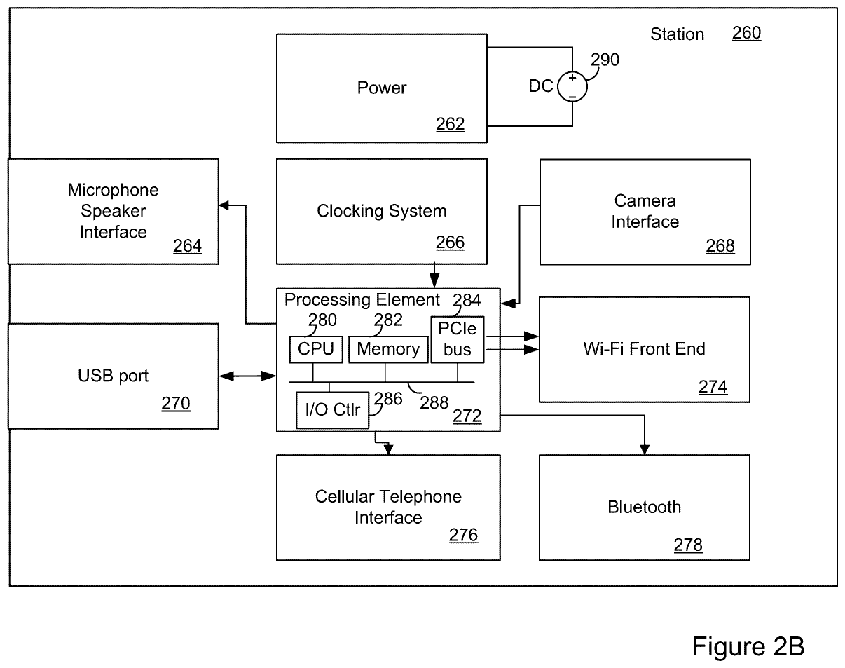

FIG. 2A depicts a representative architecture of an access point (AP), according to embodiments. The AP 220 includes a processing element 222 and several ports or connection facilities, such as a WAN port 224, USB port 226, RS-232 port 228, LAN port 230, and Bluetooth 232. Also included are a clocking system 234 and an 8×8 radio front-end 236 with a transmitter and receiver, which are coupled to eight external antennas. Auxiliary modules include a temperature sensing module 240, a power module 242 connected to a DC power source 246, a power over Ethernet (POE) module 244, and LED driver 258. The processing element 222 includes a CPU 248 and memory 250, a peripheral control interconnect express (PCle) bus controller 252 for connecting to the 8×8 radio front-end 236, and an I/O controller 254, all coupled to each other via bus 256. Memory 250 may include one or more buffers for traffic entering or exiting AP 220.

FIG. 2B depicts a representative architecture of a station, according to embodiments. Station 260 includes a processing element 272 and several ports or connection facilities, such as a USB port 270 and Bluetooth 278. Also included are a clocking system 266 and a Wi-Fi front-end 274 with a transmitter and receiver, which are coupled to an external antenna. Auxiliary modules include a power module 262 connected to a DC power source 290, a microphone and speaker interface 264 coupled to an external microphone and speaker, respectively, a camera interface 268, and a cellular telephone interface 276. The processing element 272 includes a CPU 280 and memory 282, a peripheral control interconnect express (PCle) bus controller 284 for connecting to the Wi-Fi front-end 274, and an I/O controller 286, all coupled to each other via bus 288. Memory 282 may include one or more buffers for traffic entering or exiting station 260.

To join a wireless network, stations perform a scanning operation. Parameters used in the scanning procedure include the basic service set (BSS) type, the BSS ID, the network name (SSID), the scan type (active or passive), a channel list, a probe delay before sending a probe request, and a minimum and maximum time for the scan to occupy a channel. In passive scanning, the AP sends beacon frames. In active scanning, a station sends probe request frames and receives probe response frames from APs in the receiving area. A scan report is generated at the conclusion of a scan. The report lists all the BSSs the scan discovered and their parameters.

After compiling the scan results, a station can elect to join one of the BSSs. Joining involves performing an authentication procedure and an association procedure. Once authentication is completed, stations can associate with an AP to gain full access to the network.

A re-association procedure (sometimes called roaming) is performed when a station moves from an old AP to a new one. During the re-association procedure, the station issues a re-association request to the new AP. The re-association request includes the identity of the old AP so that the new access point can determine if the old AP authenticated the station. The new AP processes the re-association request and contacts the old AP to finish the old re-association procedure. The old AP sends any buffered frames it had for the station to the new AP. The old AP then terminates its association with the station, and the new AP begins processing frames for the station.

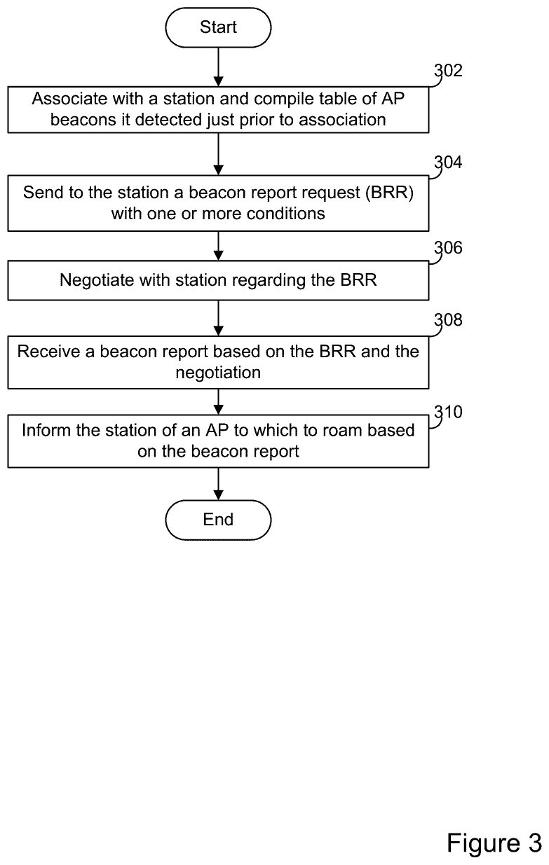

FIG. 3 depicts a flow of operations at the AP, according to embodiments. In block 302, the AP associates with a station. At association time, a station sends (solicited or unsolicited) to the AP a table reporting the AP beacons that the station has detected during a scanning phase prior to association with the station for the target SSID.

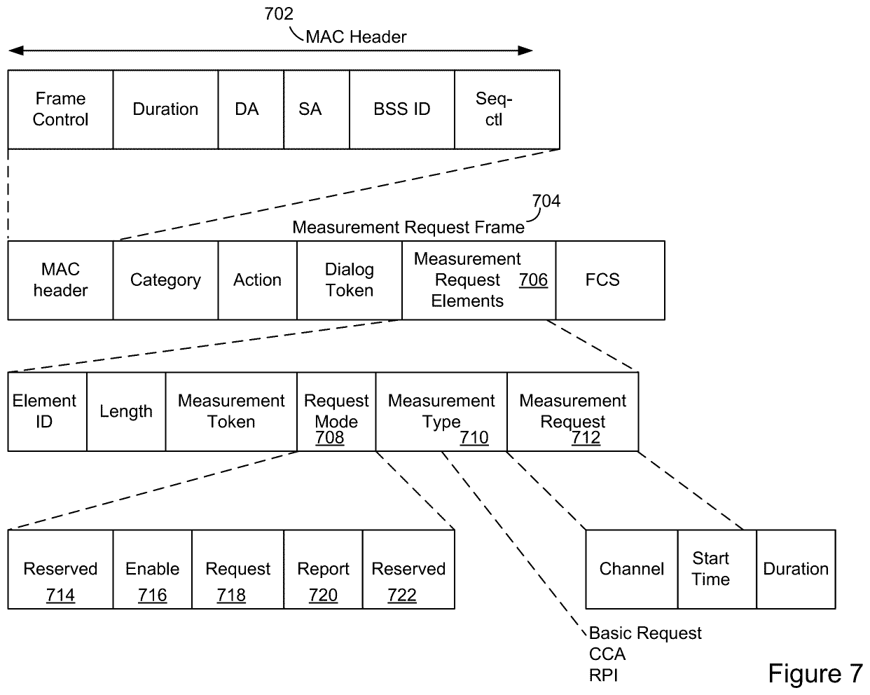

In block 304, the AP sends a beacon report request (BRR, a measurement request frame) with one or more conditions to the station. FIG. 7 depicts the measurement request frame, in which the measurement request elements specify the details of the request.

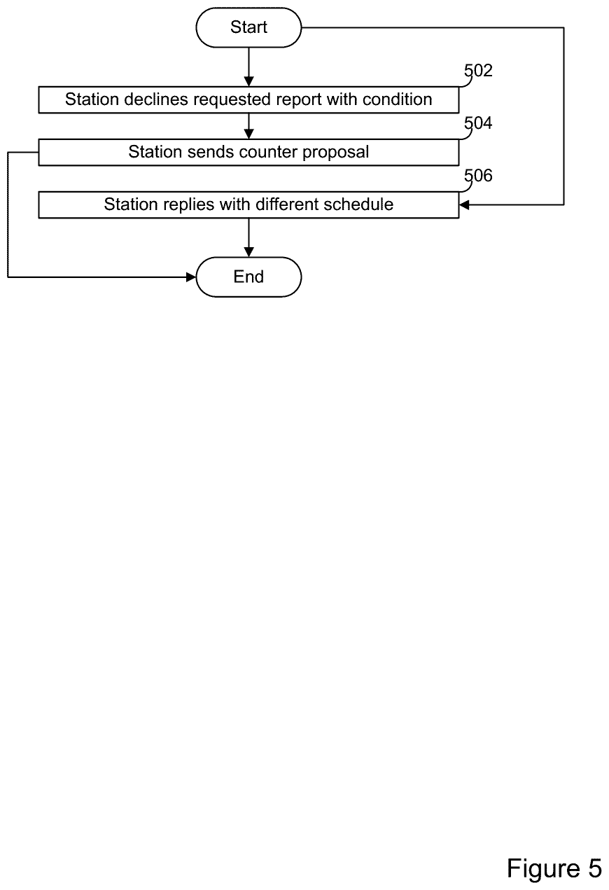

In block 306, the AP negotiates with the station regarding BRR, where the negotiation determines whether the station can meet the one or more conditions. FIG. 5 depicts a flow of operations for negotiation between the AP and a station in more detail.

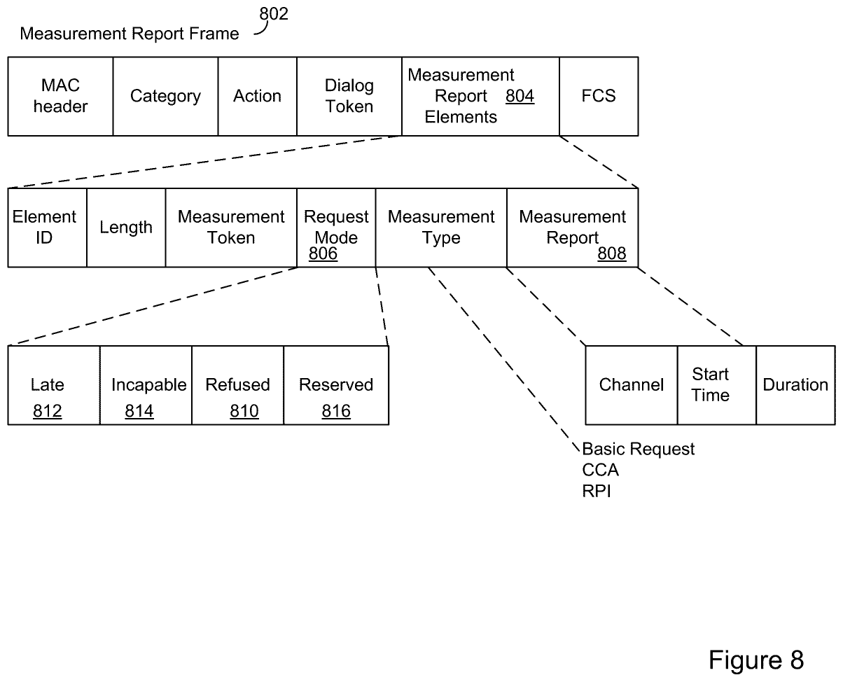

In block 308, the AP receives from the station the beacon report (a measurement report frame) based on the BRR and the negotiation. The measurement report frame, as depicted in FIG. 8, includes measurement report elements that specify the details of the report.

In block 310, the AP informs the station, based on the beacon report, of an AP to which the station should roam.

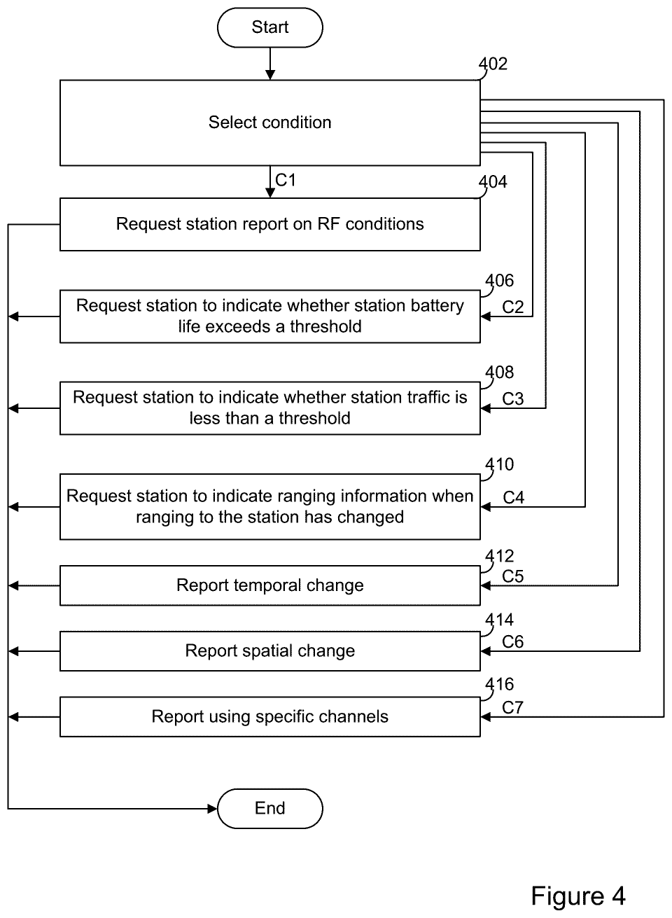

FIG. 4 depicts a flow of operations for making a measurement request with one or more conditions, according to embodiments. In block 402, the AP selects one of the conditions, C1-C7. In one embodiment, a code for each condition C1-C7 resides in a reserved field of the measurement request. In block 404, the AP selects C1, which is that the station report on its RF conditions. The RF conditions include (i) whether the received signal strength indication (RSSI) is greater than a specified threshold, e.g., whether the RSSI changed by greater than 2 dB, (ii) whether the RSSI changes by less than 2 dB, (iii) whether the RF conditions have changed based on station movement, where the station scans at regular intervals so that the AP can determine whether the station is moving.

In block 406, the AP selects C2, in which the station indicates whether the battery life of the station's battery is greater than a threshold.

In block 408, the AP selects C3, in which the station indicates whether the station traffic is less than a threshold. The indication of the station's traffic includes (i) whether the actual traffic is less than a threshold or (ii) whether the amount of data in the station's buffer is less than a threshold.

In block 410, the AP selects C4, in which the station reports ranging information when ranging to the station has changed. The station determines the ranging information to be reported by performing a ranging exchange with the AP or by providing neighboring AP details, including the channels, basic service set ID (BSSID), and location configuration information (LCI).

In block 412, the AP selects C5, in which the station reports a change in a temporal condition of the station. In one embodiment, the temporal condition includes intervals between reports (e.g., 5 seconds) or that the distance to the AP has increased by a specific distance (e.g., 1 meter).

In block 414, the AP selects C5, in which the station reports a change in a spatial condition of the station. The spatial condition includes a change in the distance from the station to the AP (e.g., a change of 2 meters).

In block 416, the AP selects C6, which specifies the channel or channels on which the station sends its beacon report or that the station use a channel it previously used. The AP may send a list of channels and operating classes to the station to help the station decide on channels.

While each selection is described separately, selections can be combined, so a requested report can have multiple condition requests.

FIG. 5 depicts a flow of operations for negotiation between the AP and a station, according to embodiments. In block 502, the station declines the requested report. In one embodiment, the station sets the refused bit in the request mode field depicted in FIG. 7. In block 504, the station sends a counter-proposal to the AP. In one embodiment, the counter-proposal is a measurement request frame with alterations compared to the received measurement request frame. The counter-proposal also includes a reason that the station cannot comply (e.g., its buffer is filling up). If the requested report is a scan and the station cannot complete the scan immediately, the counter-proposal includes a wait time and a scan after the wait time, along with a reason for the delay. Alternatively, in block 506, the station's response is a scan with a different schedule (e.g., every 8 seconds instead of every 5 seconds).

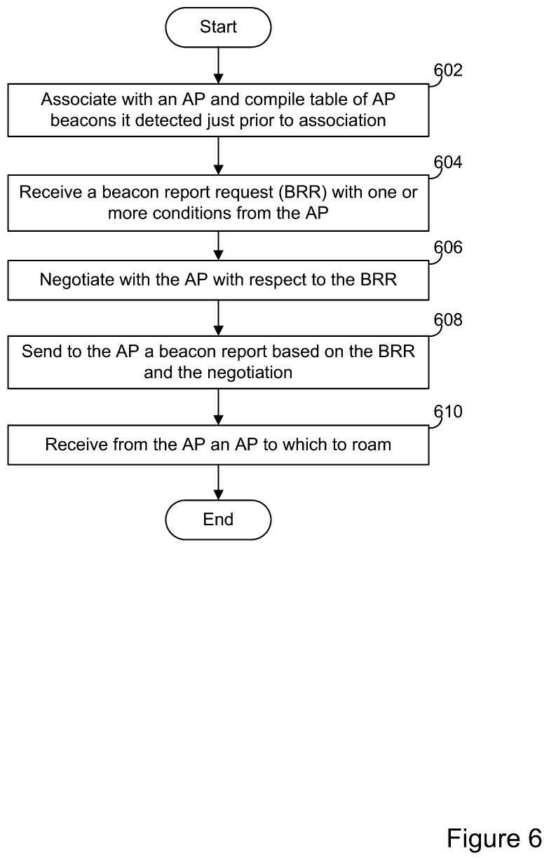

FIG. 6 depicts a flow of operations at the station, according to embodiments. In block 602, the station associates with an AP and compiles a table of AP beacons it detected prior to the association. In block 604, the station receives a BRR with one or more conditions from the AP. In block 606, the station negotiates with the AP regarding BRR. In block 608, the station sends a beacon report to the AP based on the BRR and the negotiation. In block 610, the station receives an AP from the AP, which the station should roam.

FIG. 7 depicts a measurement request frame, according to embodiments. The AP uses the measurement request frame 704 to request that a station make measurements and send the results to the requester. The measurement frame 604 includes a MAC header 702, a category field, an action field, a dialog token field, one or more measurement request elements 706, and a frame check sequence (FCS).

The category field indicates that the frame is a spectrum management frame. The action field indicates that the frame is a measurement request. The dialog token field is a sequence number to track measurement responses to outstanding requests.

Each measurement request frame 704 can make several requests by including several measurement request elements, 706, in the body of the frame. Each element 606 includes an element ID, a length, a measurement token, a request mode 608, a measurement type 710, and a measurement request 712. The measurement token identifies the particular management request element. The element ID identifies the frame type as a measurement request frame. The length gives the size of the measurement request elements 706. The measurement token identifies the measurement request by number so that different measurement requests can be distinguished.

The request mode 708 indicates the types of management frames that are supported. The request bit 718 signifies that the transmitter will process incoming measurement requests. The report bit 720 signifies that the transmitter will accept unsolicited reports. The enable bit 716 indicates when the request and report fields are valid. Fields 714 and 722 in the request mode 708 are reserved.

The measurement type field 710 includes a basic measurement, a clear channel assessment, and a receive power indication (RPI) histogram.

The measurement request 712 consists of a channel number, the value of a timer function at which the measurement should start, and the duration of the measurement. A timer start value of zero indicates that the measurement should be taken immediately.

FIG. 8 depicts a measurement report frame, according to embodiments. A station uses the measurement report frame 802 to send the result of a measurement to the requester. The frame includes a MAC header, a category field, an action field, a dialog token, and one or more measurement report elements 804.

The request mode field 806 includes a late field 812, an incapable field 814, and a refused field 810. Field 816 is reserved in the request mode field 806. The measurement report field 808 includes a channel, start time, and duration for each measurement type that was requested.

The measurement report field 808 includes a channel, a start time, and a duration, adding a map field for the basic report. For a CCA type, the measurement report field 808 includes a channel, a start time, and a duration and adds a busy function field. For an RPI type, the measurement report field 808 includes a channel, a start time, and a duration and adds a density bytes field.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer-readable medium(s) having computer-readable program code embodied thereon.

Program code embodied on a computer-readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer-readable medium that can direct a computer, other programmable data processing apparatus, or other device to function in a particular manner, such that the instructions stored in the computer-readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer-implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method of roaming, the method comprising:
associating with a station;
sending to the station a beacon report request (BRR) with one or more conditions;
performing a negotiation with the station with respect to the BRR;
receiving a beacon report from the station based on the BRR and the negotiation; and
informing the station of an AP to which to roam according to the beacon report.

2. The method of claim 1, wherein the one or more conditions include requesting that the station scan at regular intervals to determine whether radio frequency (RF) conditions of the station have changed.

3. The method of claim 1, wherein the one or more conditions include the station reporting whether its battery life exceeds a threshold.

4. The method of claim 1, wherein the one or more conditions include the station reporting whether its traffic is less than a threshold.

5. The method of claim 1, wherein the one or more conditions include the station reporting ranging information when ranging to the station has changed.

6. The method of claim 1, wherein negotiating with the station includes the station responding to the BRR with a counter-proposal.

7. The method of claim 1, wherein the one or more conditions include specifying channels for receiving the beacon report from the station.

8. An access point comprising:
a processor; and
a memory coupled to the processor and loaded with a program executable by the processor to:
associate with a station;
send to the station a beacon report request (BRR) with one or more conditions;
performing a negotiation with the station with respect to the BRR;
receive a beacon report from the station based on the BRR and the negotiation; and
inform the station of an AP to which to roam according to the beacon report.

9. The access point of claim 8, wherein the one or more conditions include requesting that the station scan at regular intervals to determine whether radio frequency (RF) conditions of the station have changed.

10. The access point of claim 8, wherein the one or more conditions include the station reporting whether its battery life exceeds a threshold.

11. The access point of claim 8, wherein the one or more conditions include the station reporting whether its traffic is less than a threshold.

12. The access point of claim 8, wherein the one or more conditions include the station reporting ranging information when ranging to the station has changed.

13. The access point of claim 8, wherein negotiating with the station includes the station responding to the BRR with a counter-proposal.

14. The access point of claim 8, wherein the one or more conditions include specifying channels for receiving the beacon report from the station.

15. A station comprising:
a processor; and
a memory coupled to the processor and loaded with a program executable by the processor to:
associate with an access point (AP);
receive a beacon report request (BRR) with one or more conditions from the AP;
perform a negotiation with the access point with respect to the BRR;
send a beacon report to the AP based on the BRR and the negotiation; and
receive from the AP an AP to which to roam.

16. The station of claim 15, wherein the one or more conditions include requesting that the station scan at regular intervals to determine whether radio frequency (RF) conditions of the station have changed.

17. The station of claim 15, wherein the one or more conditions include the station reporting whether its battery life exceeds a threshold.

18. The station of claim 15, wherein the one or more conditions include the station reporting whether its traffic is less than a threshold.

19. The station of claim 15, wherein the one or more conditions include the station reporting ranging information when ranging to the station has changed.

20. The station of claim 15, wherein the program executable by the processor to negotiate with the station includes the station responding to the BRR with a counter-proposal.
